(19) United States
(12) Patent Application Publication
(10) Pub. No.: US 2026/0169354 A1
(43) Pub. Date: Jun. 18, 2026

(54) SYSTEMS AND METHODS FOR VEHICLE CAMERA GLARE REDUCTION

(71) Applicant: Ford Global Technologies, LLC, Dearborn, MI (US)

(72) Inventor: John Ryan Peterson, Wexford, PA (US)

(73) Assignee: Ford Global Technologies, LLC, Dearborn, MI (US)

(21) Appl. No.: 18/983,754

(22) Filed: Dec. 17, 2024

(51) Int. Cl. G03B 11/00; B60R 11/00; B60R 11/04

(52) U.S. Cl. CPC G03B 11/00; B60R 2011/0026; B60R 2011/0063; B60R 11/04

(57) ABSTRACT

A system for reducing glare caused by sunlight impinging on a windscreen of a vehicle or reflecting off of surfaces and/or objects in an external environment is provided. The glare usually results in saturation of the front-facing camera and the image captured by the front-facing camera suffers from over-exposure and other issues. The system includes a plurality of louvers that may be manufactured in a film form. The long axis of the louvers is parallel to the ground and the louvers may be pitched towards the windscreen at an angle that is approximately equal to the angle that the windscreen makes with the surface normal. The louvers may be coupled to the windscreen and are installed within the housing that includes the front-facing camera. The louvers extend horizontally across the field of view of the front-facing camera and span a length of the portion of the windscreen within the housing.

### FIELD

The present disclosure relates to the field of reducing glare caused by sunlight. Specifically, embodiments of the present disclosure relate to systems and methods related to reducing glare caused by sunlight or its reflection from objects in an environment and impinging on a vehicle windscreen.

### BACKGROUND

Cameras mounted behind windscreens of vehicles often suffer from washout due to glare from the sun. In addition, most of these cameras are enclosed within a housing for protection. The operation of the cameras and the sunlight entering the housing can cause heat build-up within the housing, leading to issues with normal operation of the camera. In some conventional systems, a hood may be installed above a camera in between the windscreen and camera lens to prevent sunlight from directly shining on the camera lens, thus reducing the glare. However, the presence of such a hood causes significant loss of the vertical field of view of the camera and may cut off the upper portion of the image captured by the camera.

In some instances, sunlight can reflect off the bottom portion of the housing. Due to the shallow slope of the windscreen, the bottom portion of the housing extends significantly in front of the camera. Due to this, there is a possibility that a sizable portion of sunlight entering the housing can reflect off of the bottom portion of the housing and into the camera lens, especially when the sun is above the vehicle and/or when the sun is closer to the horizon during dawn and/or dusk.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 illustrates a portion of a windscreen with a front-facing camera enclosure/housing according to an embodiment of the present disclosure.

FIG. 4 illustrates a schematic view of a windscreen with micro-louvers according to an embodiment of the present disclosure.

FIG. 5 illustrates a schematic view of a windscreen having a plurality of micro-louvers according to another embodiment of the present disclosure.

FIG. 6 illustrates a schematic view of a windscreen with micro-louvers according to another embodiment of the present disclosure.

FIG. 7 illustrates a schematic view of a windscreen having a plurality of micro-louvers according to yet another embodiment of the present disclosure.

FIG. 8 illustrates a schematic view of a windscreen with a plurality of parallel micro-louvers according to an embodiment of the present disclosure.

FIG. 9 illustrates a schematic view of a windscreen having a plurality of tilted micro-louvers according to an embodiment of the present disclosure.

FIG. 10 illustrates a schematic view of a windscreen having a plurality of micro-louvers according to another embodiment of the present disclosure.

FIG. 11 illustrates a block diagram of a server according to an embodiment of the present disclosure.

### DETAILED DESCRIPTION

### Overview

The present disclosure describes systems and methods for using a plurality of micro-louvers behind the windscreen of a vehicle to block/reflect the off-axis light resulting from glare due to sunlight. The micro-louvers also block/reflect some sunlight when the sun is directly above the vehicle and prevent the sunlight from entering the front-facing camera enclosure. This greatly enhances the performance of a front-facing camera of a vehicle.

Embodiments of the present disclosure provide a method for a system that includes a vehicle windscreen and a camera module attached to the vehicle windscreen on a first surface of the vehicle windscreen. The camera module further includes a housing attached to the windscreen, a camera at least partially disposed in the housing, and a plurality of louvers attached to the windscreen and fully disposed within the housing. The plurality of louvers are configured to block a portion of sunlight impinging upon a second surface of the vehicle windscreen opposite the first surface.

In another instance, a vehicle is provided that includes a windscreen and a camera module attached to the windscreen. The camera module further includes a housing attached to a portion of the windscreen, a front-facing camera at least partially disposed within the housing, and

a plurality of louvers attached to the windscreen and located within the housing. Further, a long axis of each of the plurality of louvers is parallel to the ground (also referred to herein as a ground surface).

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

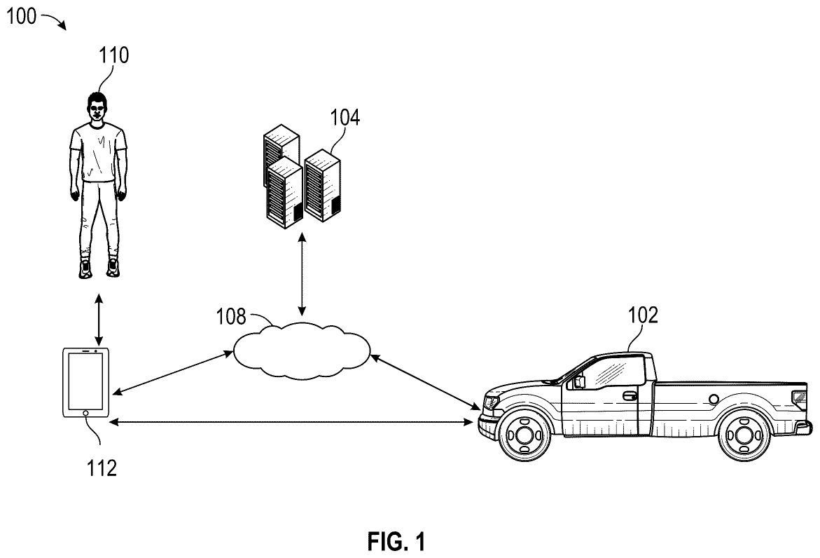

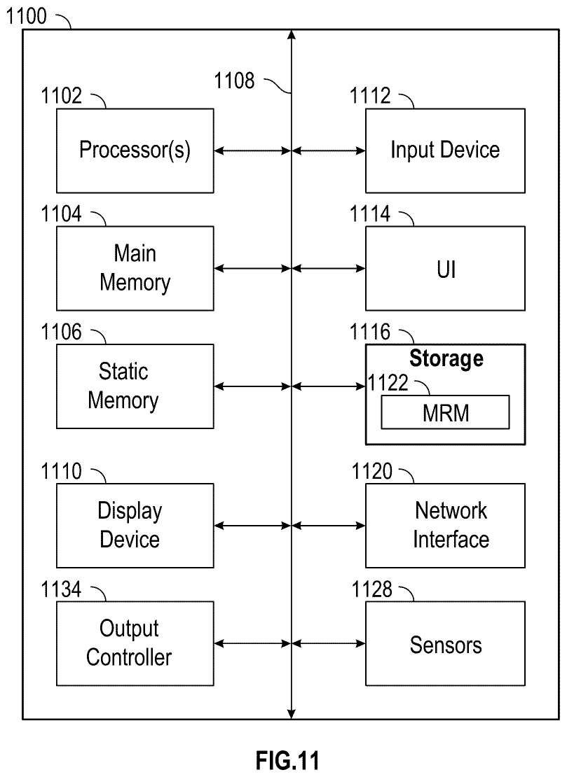

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 11.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may directly communicate with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

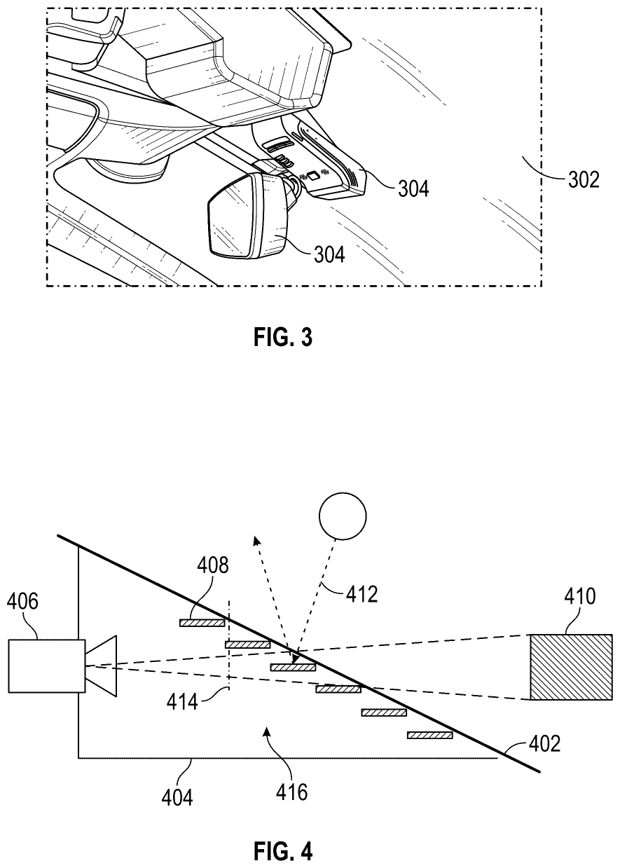

The environment 100 may also include an augmented reality (AR) device 114. The user 110 can use the augmented reality device 114 while driving to enhance his/her awareness and aid in the driving. The augmented reality device 114 may communicate directly with the vehicle 102 without the need for any intervening networks or devices. In an embodiment, the augmented reality device 114 may also communicate with the server 104 via the network 108. The augmented reality device may exchange control, configuration, and/or user profile information with the vehicle 102 and/or the server 104. Details of the augmented reality device 114 are provided with reference to FIG. 3 below.

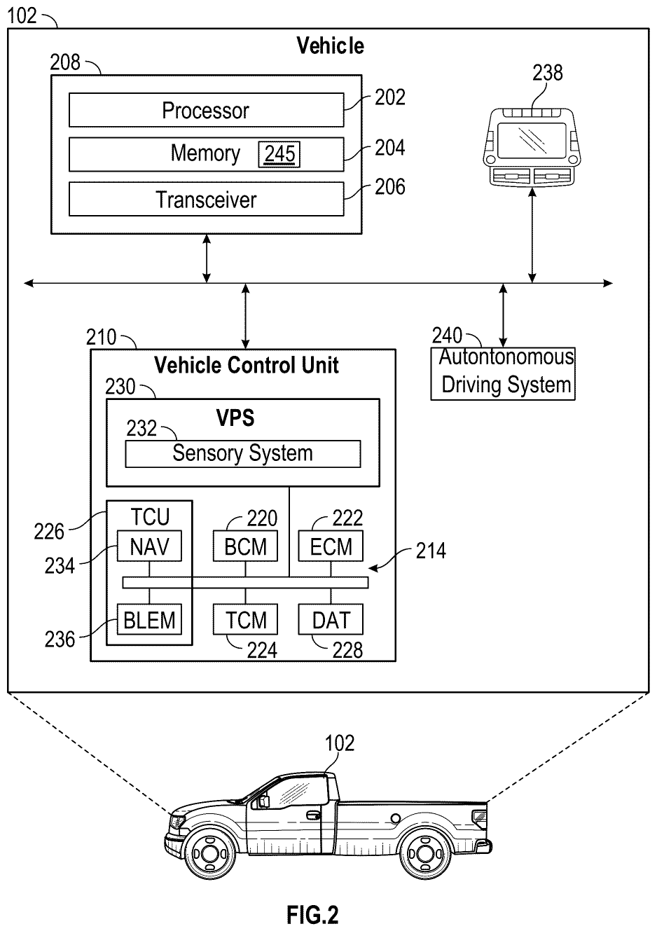

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more manner. For example, the various sensors of the vehicle sensory system 232 may be integrated into the various subsystems of the vehicle 102, such as doors, mirrors, roof, etc., or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled to the vehicles in various different ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some embodiments, the automotive computer 208 may connect with an infotainment system 238 (or a vehicle Human-Machine Interface (HMI)). The infotainment system 238 may include a touchscreen interface portion, and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion, and/or output or display notifications, navigation maps, etc. on the touchscreen interface portion. In some embodiments, the user device 112 may provide the HMI interface.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 may also include a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a vehicle stopping system that allows the driver to slow down or stop the vehicle 102. It includes components like pedals, master cylinders, lines, and pads or shoes. The vehicle 102 also includes a steering system that enables the driver to guide the car. The steering system includes components such as the steering wheel, steering column, rack and pinion, and tie rods. The vehicle 102 may also include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All of the mechanical components working together ensure that the vehicle 102 operates optimally.

Front-facing cameras are common in modern-day vehicles. Sometimes these front facing cameras are commonly referred to as “dashcams.” Usually, the front facing cameras are mounted behind the windscreens to enhance the vehicle aesthetics and aerodynamics by not disrupting the roof line or any other external surface of the vehicle. This mounting location also simplifies manufacturing and enhances the weather sealing of the vehicle. Further, the vehicle's windscreen wipers that clean the windscreen also ensure uninterrupted view for the camera lens without having to design a separate lens cleaning system for the front facing camera.

There are some disadvantages to mounting a front facing camera behind the windscreen. It is desirable for the front facing camera to be approximately parallel to the ground as possible so that the horizontal and vertical field of views are optimal to detect overhanging objects such as traffic lights as well as objects on the ground and sloped roads. Keeping the front facing camera level also keeps the center of the image, which has minimal distortion on the horizon. Due to the physical diameter of the lens, and the size of the body of the camera, as well as the thickness of the housing to hold the camera, even if the upper front corner of the camera body were to touch the windscreen, the lens itself would still be away from the center of the camera and the windscreen. This results in a gap between the camera lens and the windscreen. To protect the lens from dust and from being touched, smudged, or otherwise contacted by the user and to reduce the amount of stray light striking the lens from outside of the camera's field of view, one may choose to enclose this space from the sides and below with a housing. The side walls of this housing may typically be diagonal and/or parallel to the edges of the field of view of the camera. The lower edge of this housing cannot be too low because it would begin to obstruct the driver's field of view. However, this may create a wedge-shaped cavity between the camera and the windscreen.

To reduce the amount of direct glare from the sun being visible in our field of view as the sun gets lower in the sky, in some instances, a piece of opaque material/hood may be placed between the upper section of the lens, and the windscreen. However, this may significantly reduce the vertical field of view of the camera by cutting off the upper portion of the image. Furthermore, the boundary to the affected area of the image extends further down the image, creating a darker region (vignette) because of how the image is actually formed by the lens. Therefore, the design of the hood involves a trade-off between loss of vertical field of view and how low in the sky the sun can get before it directly shines on the front facing camera lens.

There is also the possibility of glare from the bottom portion of the housing, which serves to separate the camera cavity from the passengers. Because of the shallow slope of the windscreen, the bottom portion of the housing may extend significantly in front of the camera, and because the height of the housing cannot extend too far into the passenger compartment, the lower/bottom portion of the housing may also be directly visible in the camera image. Because the distance it extends forward is dictated by the physical height of the camera body and lens and the slope of the windscreen, it is difficult to shorten the length of the bottom portion of the housing beyond a point. Also, because the bottom/lower portion of the housing extends further forward than the upper portion of the housing, a significant amount of sunlight can reflect off the lower portion into the front facing camera's lens creating an appreciable amount of glare. Furthermore, the sunlight entering the camera cavity/housing also creates an issue of heat.

In order to mitigate the effects of glare, one option is to change the material of the housing. For example, the housing can be manufactured using low-reflectivity materials like a black fabric, but that doesn't address the heat issue. Another option is to replace the bottom portion of the housing with glass. This would have the benefit of expanding the field of view of the front-facing camera, though the lower section of the field of view would be looking through two pieces of glass (camera lens and the bottom portion), which could introduce significant distortion in the image. Glass may also introduce specular reflections from sunlight. Also, the presence of glass does not address the issue of heat buildup in the camera housing.

Embodiments of the present disclosure mitigate the shortcomings of the conventional methods explained above. FIG. 3 illustrates a portion of a windscreen with a front-facing camera enclosure/housing according to an embodiment of the present disclosure. The vehicle (e.g., vehicle 102 of FIG. 1) may have a windscreen 302 that spans a front end of the vehicle. A camera module 304 may be installed within the passenger cabin of the vehicle such that it is attached to the windscreen and/or positioned adjacent to the windscreen. One or more cameras may be included within the camera module 304. These one or more cameras are oriented such that they are front-facing, and their field of view includes a portion of the external environment in front and sides of the vehicle. Typically, the front-facing camera(s) available on the market may have a horizontal field of view between 70 degrees and 130 degrees and a vertical field of view of between 50 degrees and 90 degrees. The vehicle may also have a rear-view mirror 306 that enables the driver to see a portion of the environment behind the vehicle.

As the user is driving the vehicle, the camera module 304 is continually capturing image data within its field of view. In some instances, the data captured by the front-facing camera in the camera module 304 may be displayed in real-time on a dedicated display or on the HMI system of the vehicle. The front-facing camera(s) of the camera module 304 is affected by the changing lighting conditions in the external environment. For example, as the sun changes its position in the sky, the angle of the sun rays incident on the windscreen 302 changes accordingly. In the instance when the sun rays may be incident normal to the windscreen, the sun rays that enter the camera module 304 may reflect internally and may be captured by the front-facing camera inside the camera module 304, resulting in a reduced dynamic range of the captured image data or image data can be over-exposed, resulting in loss of details in the image. As the sun moves closer to the horizon, the sun rays may directly impinge on the lens of the front-facing camera inside the camera module 304, causing lens flare, which affects the ability of the camera to capture images and may result in the images having bright spots or streaks, a hazy glow, and/or ghosting. In addition, if the vehicle is positioned on a sloped surface, the incident sun rays may also be reflected internally causing the camera overexposure.

FIG. 4 illustrates a windscreen with micro-louvers/louvers according to an embodiment of the present disclosure that mitigates the above-mentioned issues. The windscreen 402 is usually sloped and has a certain angle with respect to the normal. The camera module may include a housing 404 that partially encloses the camera 406. For instance, a lens portion of the camera 406 is placed inside the housing 404. The housing 404 may be attached or positioned adjacent to the windscreen 402 such that the housing 404, along with the windscreen 402, creates/defines an enclosed space 416. The camera 406 is oriented such that it can capture images of an external environment of the vehicle that may include an object 410. The object 410 may include humans, road signs, trees, roads, etc., that are within the field of view of the camera 406. The windscreen 402 also includes a plurality of micro-louvers 408 that may be attached to the windscreen 402, or to a portion of the housing 404, or to a portion of the camera 406. The micro-louvers are contained within the housing 404 and may span a substantial portion of the width of the windscreen 402 within the housing 404. In an embodiment, each micro-louver 408 may be rectangular in shape and have a certain thickness, depth, and length. In an embodiment, the micro-louvers may have a thickness of between 150 nanometers and 0.5 millimeters and a depth of between 10 micrometers and 1 millimeter. The length of each micro-louver 408 is dependent on the dimensions of the housing 404. Each micro-louver is long enough to span a substantial portion of the width of the windscreen 402 that is associated with the housing 404 or within the housing 404 and runs across the field of view of the camera 406 from the left to the right. In an embodiment, the long axis of each micro-louver 408 is oriented parallel to the ground. By placing the long axis of each micro-louver 408 horizontally, the horizontal field of view of the camera 406 is not impeded and the camera 406 can still see the object 410 that is in front of the vehicle and to either side of the vehicle. In an embodiment, the pitch between adjacent micro-louvers 408 can be between 10 micrometers and 2 millimeters.

In an embodiment, each micro-louver 408 is parallel to its adjacent micro-louver and to the other micro-louvers. The number of micro-louvers may be different for different camera modules and may depend on the size and shape of the housing 404. A larger housing may need a greater number of micro-louvers 408 while a smaller housing may need a smaller number of micro-louvers. The micro-louvers 408 block the off-axis light waves that cause glare from entering the housing 404, thus enhance the performance of the camera 406. When the sun is located above the vehicle, the micro-louvers 408 also help to block/reflect the sunlight 412 away from the windscreen 402. In an embodiment, the micro-louvers are placed such that a first edge 414 of a first micro-louver 408 aligns with a second edge of a second micro-louver that is immediately adjacent to the first micro-louver 408. In this manner, there is no gap in coverage between the micro-louvers 408. In some embodiments, the micro-louvers 408 may not all be parallel to each other. Instead, a first number of micro-louvers may be pitched toward the windscreen 402, and a second number of micro-louvers 408 may be pitched away from the windscreen 402. For instance, the micro-louvers 408 that are above a horizontal axis of the camera may be pitched away from the windscreen 402, and the micro-louvers 408 that are below the horizontal axis of the camera may be pitched towards the windscreen 402. In other embodiments, the pitch of each of the micro-louvers may be different than the pitch of an adjacent micro-louver.

In an embodiment, the micro-louvers 408 may be fabricated as a single film that can be attached or adhered to the windscreen 402. The entire micro-louver film will be contained within the housing 404. Such a film can be installed easily and efficiently. In addition, since the film is adhered to the windscreen 402, the windscreen 402 may also act as a heat sink to dissipate the heat that may be built up within the housing 404 and the film. In an embodiment, the film can be manufactured using a polycarbonate material. In other embodiments, the micro-louvers 408 may be manufactured using a fabric or a metal mesh. In some embodiments, the micro-louvers may be manufactured using different colored materials. For example, instead of the traditional black color, the micro-louvers 408 may be white in color or can be made of a reflective material, such as silver. The white/reflective color may be helpful in enhancing the heat rejection of the camera module. In other embodiments, the micro-louvers may be multi-colored.

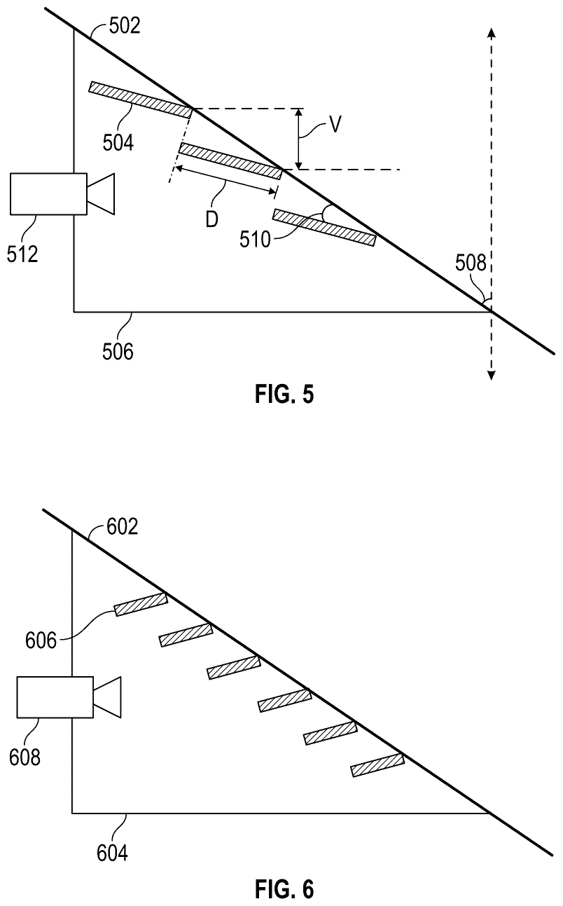

FIG. 5 illustrates a windscreen 502 having micro-louvers according to another embodiment of the present disclosure. In this embodiment, the micro-louvers 504 are pitched at an angle 510 with respect to the windscreen 502. As can be seen, the windscreen 502 itself is sloped and makes an angle 508 with the normal to the ground surface. In an embodiment, the angle 510 of the micro-louvers 504 can be adjusted such that the angle 510 is approximately same as the angle 508. In some instances, the angle 510 is substantially or exactly equal to the angle 508. The long axis of the micro-louvers 504 is substantially parallel to the ground surface such that the camera 512 is able to see objects in front of the vehicle and its horizontal field of view is not impeded. Further, the micro-louvers 504 are small enough to avoid being captured as horizontal bars within any captured image. In addition, pitching/tilting the micro-louvers 504 towards the windscreen 502 also effectively blocks/reflects sunlight impinging on the windscreen 502 when the sun is directly above the vehicle. The micro-louvers 504 may span the entire length of the windscreen 502 that is part of the housing 506. The vertical distance between the micro-louvers 504 (i.e., how closely the micro-louvers are packed) can be adjusted based on the type of material used to manufacture the micro-louvers and/or the field of view of the camera 512. For example, if the camera 512 has a narrow field of view the micro-louvers 504 may be spaced farther apart than if the camera 512 has a wide/large field of view. In an embodiment, each louver 504 may be characterized by a depth or width ‘D,’ and all the louvers 504 may have identical depth values. In other embodiments, some or all of the louvers 504 may have different depth values from each other. In some embodiments, all the louvers may be spaced apart from each other by the same vertical distance ‘V’. In other embodiments, the vertical distance ‘V’ between two immediately adjacent louvers 504 may vary across the total height of the plurality of louvers. For example, since the bottom portion of the housing 506 extends further towards the windscreen 502 than a top portion of the housing 506, the louvers 504 closer to the bottom portion of the housing 506 may be spread farther apart than louvers 504 located near the top end of the housing 506. This variation in the depth ‘D” and the vertical distance ‘V’ may also be implemented in all other embodiments illustrated in this disclosure.

FIG. 6 illustrates a windscreen 602 with micro-louvers 606 according to another embodiment of the present disclosure. In this embodiment, the micro-louvers 606 are pitched or tilted away from the windscreen 602. As in the other embodiments, the angle of this tilt can be adjusted based on the specifications of the camera 608 and/or the slope of the windscreen 602. In this embodiment, the long axis of the micro-louvers 606 is substantially parallel to the ground, and the micro-louvers 606 spans substantially the entire length of the windscreen 602 within the camera module housing 604.

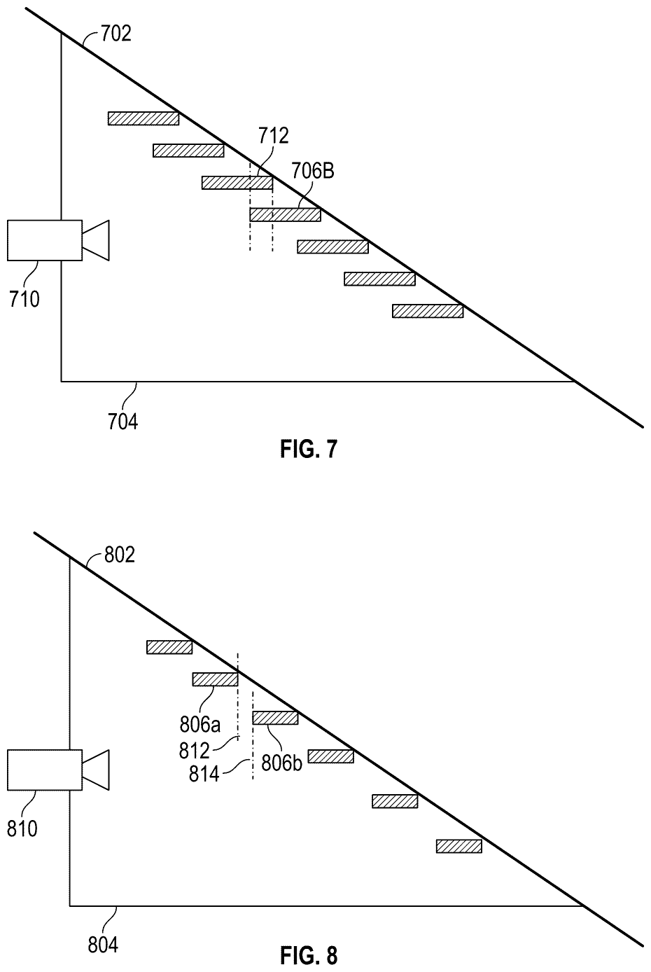

FIG. 7 illustrates a windscreen 702 having a plurality of micro-louvers according to yet another embodiment of the present disclosure. In this embodiment, the micro-louvers are arranged such that at least a first portion 712 of a first micro-louver 706a overlaps with a second portion 714 of a second micro-louver 706b. In this instance, the first micro-louver 706a is immediately adjacent to the second micro-louver 706b. All of the micro-louvers are arranged in a similar manner where a portion of a micro-louver overlaps with a portion of another micro-louver immediately adjacent to it in either direction. Overlapping the micro-louvers in this manner prevents or at least severely restricts any sunlight from impinging on the bottom surface of the housing 704 and eliminates the possibility of reflection caused by the bottom surface of the housing 704. In the instance where the micro-louvers 706 overlap, each micro-louver 706 may have a different pitch angle with respect to each other and/or with respect to the windscreen.

FIG. 8 illustrates a windscreen 802 with a plurality of micro-louvers 806 according to an embodiment of the present disclosure. As illustrated, in this embodiment, the micro-louvers 806 are arranged such that a first edge 812 of a first micro-louver 806a is separated by a distance from a second edge 814 of a second micro-louver 806b. This results in a gap between two adjacent micro-louvers 806. In this arrangement, the number of micro-louvers needed may be reduced, and/or the depth of the micro-louvers may be reduced compared to the other embodiments for a given area of the housing 804. In another instance, the vertical distance between adjacent micro-lovers 806 may be greater compared to the other embodiments. In this embodiment, the camera 810 has a good horizontal field of view.

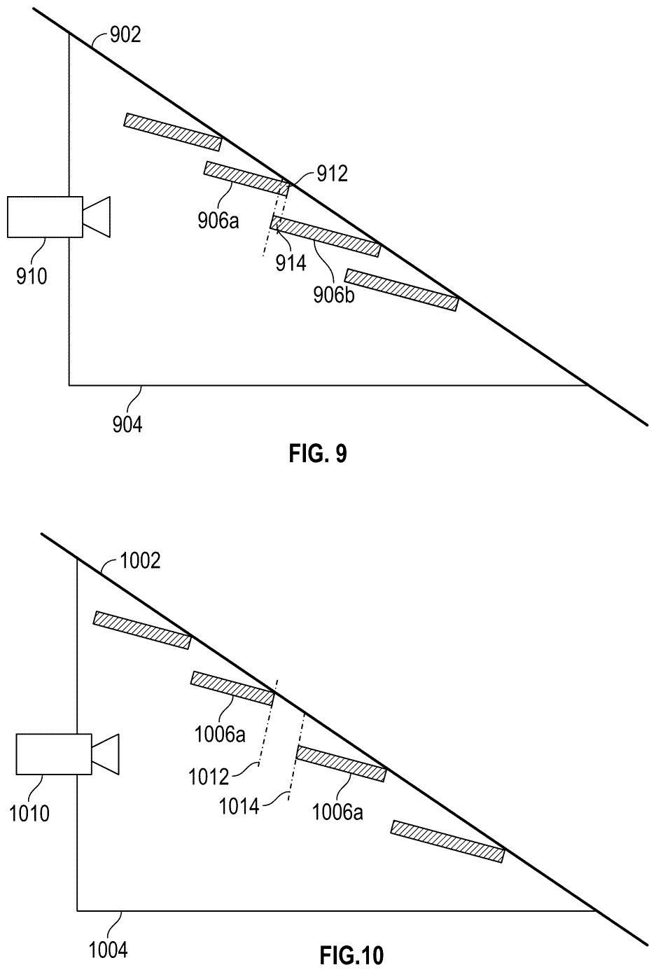

FIG. 9 illustrates a windscreen 902 having a plurality of micro-louvers 906 according to an embodiment of the present disclosure. The micro-louvers 906 in this embodiment are arranged similarly to the embodiment illustrated in FIG. 5. The main difference between this embodiment and the embodiment illustrated in FIG. 5 is that each micro-louver 906 overlaps at least partially with an immediately adjacent micro-louver. For example, micro-louver 906a has a portion 912 that overlaps with a portion 914 of the adjacent micro-louver 906b. The overlap may help with reflecting/blocking sunlight that directly impinges on the windscreen 902 from above, thereby preventing that sunlight from reaching the bottom surface of the housing 904. This further prevents the possibility of internal reflection within the housing from reaching the lens of the camera 910.

FIG. 10 illustrates a windscreen 1002 having a plurality of micro-louvers 1006 according to another embodiment of the present disclosure. The micro-louvers 1006 in this embodiment are arranged similarly to the embodiment illustrated in FIG. 5. The main difference between this embodiment and the embodiment illustrated in FIG. 5 is that in this embodiment, the micro-louvers 1006 are arranged such that there is no overlap between immediately adjacent micro-louvers. As illustrated, an edge 1012 of a first micro-louver 1006a is separated from the edge 1014 of the second micro-louver 1006a creating a gap in coverage between the two immediately adjacent micro-louvers 1006a and 1006b. This may result in requiring less number of micro-louvers to cover the area of the windscreen 1002 within the housing 1004 while still providing a wide horizontal field of view for the camera 1010 and rejecting or blocking the off-axis light from reaching the camera 1010. In the present disclosure, the terms “louvers” and “micro-louvers” are used interchangeably, and they both refer to the same or similar features.

FIG. 11 depicts a block diagram of an example control server 1100 (e.g., control server 104 of FIG. 1) in accordance with one or more example embodiments of the present disclosure. In other embodiments, the server 1100 may operate as a standalone device or may be connected (e.g., networked) to other servers. In a networked deployment, the server 1100 may operate in the capacity of a server machine, a client machine, or both in server-client network environments. In an example, the server 1100 may act as a peer server in peer-to-peer (P2P) (or other distributed) network environments. The server 1100 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The server 1100 may further include a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The server 1100 may additionally include a storage device (i.e., drive unit) 1116, a network interface device/transceiver 1120 coupled to antenna(s), and one or more sensors 1128, such as a global positioning system (GPS) sensor, a compass, an accelerometer, or other sensor. The server 1100 may include an output controller 1134, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 1116 may include a machine-readable medium 1122 on which is stored one or more sets of data structures or instructions (e.g., software) embodying or utilized by any one or more of the techniques or functions described herein. The instructions may also reside, completely or at least partially, within the main memory 1104, within the static memory 1106, or within the hardware processor 1102 during execution thereof by the server 1100. In an example, one or any combination of the hardware processor 1102, the main memory 1104, the static memory 1106, or the storage device 1116 may constitute machine-readable media.

While the machine-readable medium 1122 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

The term “machine-readable medium” may include any medium that is capable of storing, encoding, or carrying instructions for execution by the server 1100 and that causes the server 1100 to perform any one or more of the techniques of the present disclosure or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 1100 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner/driver based on recommendations or notifications provided by the vehicle should comply with all the rules specific to the location and operation of the vehicle (e.g., Federal, state, country, city, etc.). The recommendation or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. Certain terms are used throughout the description, and claims refer to particular system components. As one skilled in the art will appreciate, components may be referred to by different names. This document does not intend to distinguish between components that differ in name but not function.

It should also be understood that the word “example,” as used herein, is intended to be non-exclusionary and non-limiting in nature. More particularly, the word “example,” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a windscreen; and
a camera module positioned adjacent to the windscreen, the camera module comprising:
a housing coupled to a portion of the windscreen;
a front-facing camera at least partially disposed within the housing; and
a plurality of louvers coupled to the windscreen and located within the housing,
wherein a long axis of each of the plurality of louvers is parallel to a ground surface.

2. The vehicle of claim 1, wherein each of the plurality of louvers is pitched at an acute angle with respect to the windscreen.

3. The vehicle of claim 1, wherein the windscreen makes a first angle with a normal to the ground surface and each of the plurality of the louvers makes a second angle with respect to the windscreen, and wherein the first angle is equal to the second angle.

4. The vehicle of claim 3, wherein the first angle and the second angle are acute angles.

5. The vehicle of claim 1, wherein the plurality of louvers includes a first louver and a second louver, and wherein a first portion of the first louver overlaps with a second portion of the second louver.

6. The vehicle of claim 5, wherein the first louver is adjacent to the second louver.

7. The vehicle of claim 1, wherein a first louver of the plurality of louvers comprises a metal embedded in a fabric.

8. The vehicle of claim 1, wherein the plurality of louvers includes a first louver and a second louver, and wherein the first louver does not overlap with the second louver.

9. The vehicle of claim 1, wherein a first louver of the plurality of louvers comprises a film adhered to the windscreen.

10. A system comprising:
a windscreen of a vehicle; and
a camera module coupled to the windscreen at a first surface of the windscreen, the camera module comprising:
a housing positioned adjacent to the windscreen;
a camera at least partially disposed in the housing; and
a plurality of louvers attached to the windscreen and fully disposed within the housing, wherein the plurality of louvers are configured to block light waves impinging upon a second surface of the windscreen opposite the first surface.

11. The system of claim 10, wherein the plurality of louvers comprises a metal.

12. The system of claim 10, wherein each of the plurality of louvers has a long axis that is parallel to a ground surface and each of the plurality of louvers spans a width of a portion of the windscreen associated with the housing.

13. The system of claim 10, wherein each of the plurality of louvers is pitched at a first angle with respect to the windscreen.

14. The system of claim 13, wherein the windscreen makes a second angle with respect to a normal and wherein the second angle is equal in value to the first angle.

15. The system of claim 10, wherein the plurality of louvers are arranged parallel to each other.

16. The system of claim 10, wherein the plurality of louvers are arranged such that there is no overlap between immediately adjacent louvers.

17. The system of claim 10, wherein the plurality of louvers are in a form a film that is adhered to a portion of the first surface of the windscreen.

18. The system of claim 17, wherein the film comprises a polycarbonate material.

19. The system of claim 10, wherein the plurality of louvers are stacked in a vertical direction wherein each louver of the plurality of louvers is separated from an adjacent louver by a distance.

20. The system of claim 10, wherein a first louver of the plurality of louvers is pitched at a first angle and a second louver of the plurality of louvers is pitched at a second angle that is different from the first angle.
